(19) United States
(12) Patent Application Publication
(10) Pub. No.: US 2006/0129279 A1
(43) Pub. Date: Jun. 15, 2006

(54) Mobile emergency filtration system and method

(76) Inventors: Dennis McGuire, Stuart, FL (US); Michael R. Donn SR., Stuart, FL (US)

Correspondence Address: MCHALE & SLAVIN, P.A., 2855 PGA BLVD, PALM BEACH GARDENS, FL, 33410, US

(21) Appl. No.: 11/244,317

(22) Filed: Oct. 5, 2005

Related U.S. Application Data
(60) Provisional application No. 60/616,756, filed on Oct. 6, 2004.

(51) Int. Cl. G05B 21/00

(52) U.S. Cl. 700/273

(57) ABSTRACT

A fee basis program for emergency response to accidental or intentional contamination of a water supply includes supplying equipment designed to treat contaminated water and restore it to desired levels of usability. The program also includes provisions for training of crews, determination of optimum numbers of treatment units, deployment of the equipment, and response times. Included in the program is a fee schedule for acquisition and use of the treatment units and a monitoring function tabulating the use of each unit.

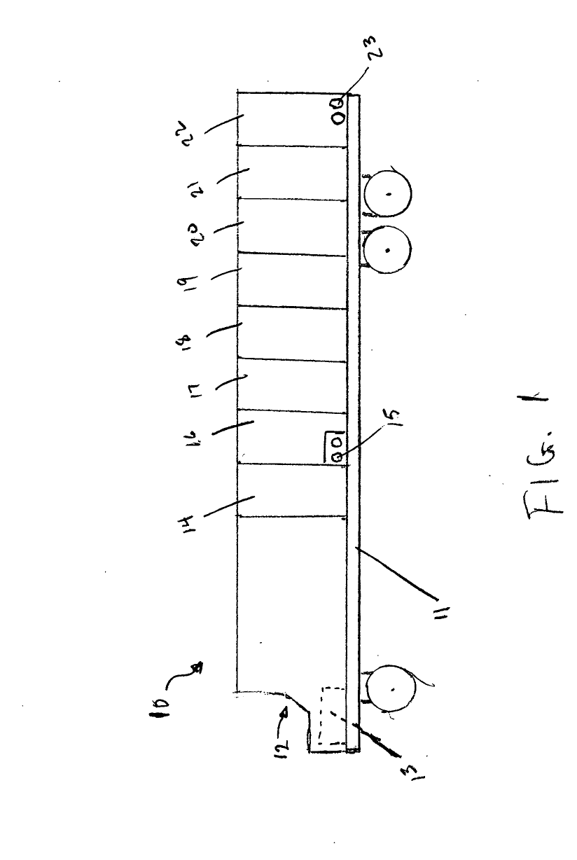

### RELATED APPLICATIONS

This application claims a priority date of Oct. 6, 2004, the filing date of Provisional Application No. 60/616,756.

### BACKGROUND OF THE INVENTION

This invention relates to procedures for providing emergency treatment of contaminated water supplies of any jurisdiction controlling or physically including a source of water available to the public.

### SUMMARY OF THE INVENTION

In the aftermath of the events of Sep. 11, 2001, the emergency response capability of most governmental agencies charged with such a mission has undergone a thorough review. In reviewing the tools and programs available to emergency response agencies, such as the police, fire and rescue departments, hospitals, etc. of towns, cities, counties, states, and the federal government, certain inadequacies were uncovered. For example, at the time of the attack it was discovered that most water municipalities did not have any capability of responding to contamination of the water supply to assure usable water for the public in the affected area.

What is needed is a plan and equipment to facilitate a rapid response to water contamination to treat the water and remove the contaminants.

Accordingly, it is an objective of this invention to provide mobile equipment for treating water to remove contaminants deleterious to health.

It is another objective of this invention to provide programs, tailored to specific jurisdictions, for the implementation of the particular program.

It is a further objective of this invention to provide programs, tailored to specific jurisdiction, for the deployment of the equipment.

### BRIEF DESCRIPTION OF THE DRAWING

The FIGURE is a block diagram of the water treatment unit of this invention.

### DETAILED DESCRIPTION OF THE INVENTION

The treating unit 10 is a mobile containerized water treatment facility. The container may be mounted on a wheeled or tracked chassis 11 having its own prime mover 12, in the form of a engine 13 and drive train or a separate wheeled or tracked tractor. In addition, the container, with or without chassis and prime mover, is air mobile or it can be moved by rail and ship.

The prime mover engine 13 may be used to power the water treatment elements or a separate generator 14 can be an integral part of the unit. Of course, the unit has a receptacle or plug-in and wiring harness for outside electric power.

The water treating unit has an inlet 15 to connect to a local source of water, eg., a water main, a water line for a building, an aqueduct from a reservoir, or a fire hydrant. Various adapters can be carried by the unit for connecting the inlet with the outside source.

The water treating unit has an element 16 to reduce super chlorinated water to usable and/or potable levels. The incoming water passes through a centrifuge 17 to remove physical contaminants, such as gravel, twigs, glass particles, etc. Also, present is a reverse osmosis chamber 18, an activated charcoal chamber 19, a hyperbaric chamber 20 which can be oxygen enriched and fitted with spray heads for aeration (not shown). A radiation chamber 21 is connected in line to irradiate the flow of water in the infrared and ultraviolet spectra. The chambers are connected by piping to conduct the treated water from one chamber to another. The piping is capable of routing the water through different chambers in a different order depending on the contaminant. In the alternative, each of the chambers is removable from the unit to tailor the treatment to the contaminant. The treated water passes through a testing chamber 22 before exiting through outlet 23. The treated water is free of chemical and biological contaminants in concentrations deleterious to the health of humans coming into contact with the water.

The water flowing out of the unit outlet is usable. The term “usable” includes water quality either for contact with humans and/or potable water depending on the contaminant and the elements of the unit by which the incoming water is treated.

On the financial side, the treating units are designed and built by private enterprise. The treating units would be stocked and maintained by private enterprise including highly trained crews. These units would be offered on a fee basis to private and government agencies that are responsible for a first response to disasters and terrorist strikes. The presence of the treating units would insure the capability of providing usable water to the public or facility for the payment of a premium.

A computer program would facilitate the financial and tactical decisions with the input of information including determining the number of treating units necessary for a geographical area based on data showing such things as population, gallons per day usage, types of uses, ie., potable or otherwise, size of the area, suitable hook-up locations, amount of training needed, etc. and determining a fee for each treating unit and a total fee for treating units and service. Providing the optimum number of units upon payment of the total fee. In the event the recommended number of units is beyond the budget of the agency or company, revising the number of treating units to be employed.

Once the number of treating units is fixed, the optimum placement of the units within the geographical area is determined assuming the optimum number of treating units is financially practical. If a lesser than optimum number is selected, the program is prioritized to select the more critical locations for deployment and the treating units are so dispersed.

The program also includes a dispatch communication system for each treating unit with the dispatcher function facilitated by at least one computer having a CPU and memory. The location of each of said plurality of treating units is entered and the computer program is capable of updating said location when any of the treating unit changes location with the program capable of calculating distance of all of the treating units to a given crisis point and determining which one of said treating units is closest to said point.

The program also provides a dispatcher function with communications with emergency response agencies for input of data, such as alerting the dispatcher function to fix a point of a contaminated water supply. The dispatcher function then notifies at least one of the treating units closest to the fixed point.

The first response team notified then moves their treating unit to the fixed point, connects said notified treating unit to the contaminated water supply, and begins treating the contaminated water to remove the contamination.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of providing emergency response to contamination of a water supply comprising the steps of:
a) providing a plurality of mobile treating units, said treating units including filtration devices;
b) dispersing said plurality of treating units about a geographical area;
c) providing a dispatcher function, said dispatcher function including a dispatch communication system for each treating unit, said dispatcher function facilitated by at least one computer having a CPU and memory;
d) programming said computer with the location of each of said plurality of treating units, said computer program capable of updating said location when any of said plurality of said treating unit changes location, said program capable of calculating distance of all of said plurality of treating units to a given point and determining which one of said treating units is closest to said point;
e) providing said dispatcher function with communications with emergency response agencies;
f) said emergency response agencies alerting said dispatcher function to fix a point of a contaminated water supply;
g) said dispatcher function notifying at least one of said plurality of treating units closest to said point;
h) moving said notified treating unit to said point;
i) connecting said notified treating unit to said contaminated water supply; and
j) treating said contaminated water to remove said contamination.

2. A method of providing emergency response to contamination of a water supply of claim 1 comprising the steps of:
a) providing said plurality of treating units to an emergency response agency responsible for a geographical area;
b) determining the number of treating units required by said agency;
c) computing a financial plan available to said agency, said plan determining the number of treating units necessary for each geographical area;
d) establishing a cost per each of said plurality of treating units to supply and maintain each of said plurality of said treating units;
e) preparing a fee schedule for each said agency determined in part by the number of treating units and the operation time performed by each of said plurality of treating units for training each said agency, costs of materials, wear and tear on said treating units, and depreciation;
f) recording payment of said fees;
g) indicating non-payment of said fees by any said agency; and
h) disabling said dispatching function for said plurality of treating units in said geographical area for non-payment of said fees.

3. A mobile water treating unit for removing contaminants from the water supply comprising a chassis, several operationally connected water treatment chambers mounted on said chassis including a water inlet, a generator mounted on said chassis for producing electrical power sufficient for operation of said unit, a wiring harness for distribution of said electrical power, said water treatment chambers having means for producing usable water and a water outlet mounted on said chassis for distribution of said usable water.

4. A mobile water treating unit of claim 3 wherein said water treatment chambers include a reverse osmosis chamber.

5. A mobile water treating unit of claim 4 wherein said water treatment chambers include a centrifuge.

6. A mobile water treating unit of claim 5 wherein said water treatment chambers include an activated charcoal chamber.

7. A mobile water treating unit of claim 6 wherein said water treatment chambers include radiation chamber.

8. A mobile water treating unit of claim 7 wherein said water treatment chambers include a testing chamber.

9. A mobile water treating unit of claim 8 wherein said water treatment chambers include hyperbaric chamber.

10. A mobile water treating unit of claim 8 wherein said chassis has sufficient strength, rigidity and lightweight to be air lifted and deployed.

11. A mobile water treating unit of claim 10 wherein said chassis is mounted on wheels.

12. A mobile water treating unit of claim 11 wherein an engine is mounted on said chassis, said engine operatively connected to said wheels.
